(19) United States
(12) Patent Application Publication
(10) Pub. No.: US 2008/0000577 A1
(43) Pub. Date: Jan. 3, 2008

(54) Adhesive bonding arrangement for adhesively bonding two structural elements and method for producing an adhesive bond between two structural elements

(75) Inventor: Alexei Vichniakov, Wenzendorf (DE)

Correspondence Address: GREER, BURNS & CRAIN, LTD., Suite 2500, 300 South Wacker Drive, Chicago, IL, 60606, US

(73) Assignee: Airbus Deutschland GmbH

(21) Appl. No.: 11/810,658

(22) Filed: Jun. 6, 2007

Related U.S. Application Data
(60) Provisional application No. 60/811,803, filed on Jun. 7, 2006.

(51) Int. Cl. B32B 37/00; B32B 15/04

(52) U.S. Cl. 156/182; 428/332; 428/336; 428/457

(57) ABSTRACT

The present invention relates to an adhesive bonding arrangement and a method for producing an adhesive bond between two structural elements, especially of an aircraft or spacecraft, with the following method steps: providing a first structural element of a first material and with at least one first bonding surface; providing a second structural element of a second material, which differs from the first material, and with at least one second bonding surface; applying a coating, which has the second material of the second structural element, at least on the first bonding surface of the first structural element; and providing an adhesive bond between the coating, which is applied to the first bonding surface of the first structural element, and the second bonding surface of the second structural element, for adhesively bonding the same to each other.

### FIELD OF THE INVENTION

The invention relates to an adhesive bonding arrangement for adhesively bonding two structural elements, and a method for adhesively bonding two structural elements, especially in the field of air and space travel.

### BACKGROUND ART

Lightweight structures in aircraft construction typically comprise thin-walled structural elements, such as panels, an outer skin, stringers, frames, ribs and suchlike of aluminium materials, which are interconnected by means of riveted connections. In the regions of particularly large stresses, like, for example, in the region of door, window or hatch cut-outs, in the region of the wing and tail section roots, or in the region of door or hatch corners, it is customary to provide additional structural elements in the form of stiffeners, doublers, crack-stoppers and suchlike of high-strength materials, like, for example, titanium or titanium alloys. Titanium materials, like pure titanium and titanium alloys, have very good mechanical properties and also high fatigue strength. Crack-stoppers and doublers of titanium materials enable the fuselage structure to be strengthened, as a result of which the level of mechanical stresses is reduced and the service life of the fuselage structure increased.

Crack-stoppers as well as doublers of titanium material currently are primarily used in two regions of the aircraft structure.

For one thing, crack-stoppers of titanium material are riveted to the longitudinal seams in the region of the frames. It is the principal task of the crack-stoppers to prevent the propagation of cracks which originate in the region of the longitudinal seam. This takes place by means of prevention of the growth of the crack beneath the crack-stopper or by means of crack deflection of the longitudinal seam into a region in which this crack is quickly detectable. Especially in the case of larger cracks, like, for example, after damage of the fuselage structure during takeoff, the crack-stoppers prevent the propagation of the crack into the next section and as a result minimize the consequences of incalculable damage.

For another thing, doublers of titanium material are riveted in the region of the passenger door corners and cargo hatch corners in the aircraft fuselage. It is the principal task of the doublers to prevent crack development of the door and hatch corners. This takes place by means of reduction of the mechanical stresses in the door corner and hatch corner regions, and by means of prevention of the crack growth beneath the doubler.

Riveting represents in this case a connecting method, which is proven and has been used for several decades in aircraft construction, for connecting individual structural elements to structural components, for example for connecting stringers and clips to outer skin, and also for connecting components to an aircraft structure, for example for connecting individual shells to a fuselage section, connecting fuselage sections to a fuselage, and connecting wings to fuselage and suchlike. Riveting of crack-stoppers and doublers of titanium to structural elements of aluminium materials has an adequate mechanical strength. The use of surface protection means leads to a constant resistance to corrosion.

In addition to long processing times, reduced fatigue resistance properties are also counted among the disadvantages of riveted structural elements. Stress concentrations and, as a consequence of material fatigue, micro-cracks, originate in the region of the rivet holes. For example, the number of rivets which are used in the region of the doublers on the door corners and hatch corners amounts to over 10 000. This results in a deterioration of the fatigue resistance properties, which at present can only be remedied by increasing the thickness of individual structural elements. These measures, however, lead to an increase of weight of the aircraft structure, and also to the disadvantages which are associated with it. Furthermore, methods are known for connecting individual structural elements to structural components of an aircraft structure which manage without rivet holes. Adhesive bonding and welding methods for connecting individual skin panels and also for connecting skin panels to stiffening elements, are counted among these.

A structural component in a welded skin-stringer type of construction is known from publications DE 196 39 667 or DE 198 44 035. Profiles which are formed as stringers or frames are welded to large-sized skin panels by means of laser beam welding. Laser beam welding enables a secure linear connection between individual structural elements. A large-area connection between individual structural elements of aluminium materials and structural elements of titanium materials up to now is still not realizable in aircraft construction for technical reasons and for corrosion reasons.

A structural component in an adhesively bonded skin-stringer type of construction is known from publication EP 1 393 893. Large-sized skin panels in this case are connected by means of adhesive bonding to lattice-like framework structures. Adhesive bonding in aircraft construction enables production of more secure and corrosion-resistant, large-area connections between structural elements which predominantly comprise aluminium materials.

Adhesively bonding structural elements of titanium materials, for example, to structural elements of aluminium materials up to now is still not used. The reason for this lies in the substantial cost for pretreatment of the surfaces of titanium materials. The known pretreatment methods for adhesively bonding titanium materials comprise treating the surfaces of titanium materials by sand blasting or by abrading means, and consequently are not applicable for industrial application in aircraft construction. Furthermore, during the adhesive bonding of different materials the problem arises that each material requires a special pretreatment of its own.

### SUMMARY OF THE INVENTION

The invention is based on the object of providing an adhesive bonding arrangement and a method for producing an adhesive bond between structural elements, which are especially industrially applicable in aircraft construction, and which keep the cost for pretreatment of the structural elements which are to be adhesively bonded to each other as low as possible.

This object according to the invention is achieved by means of the adhesive bonding arrangement with the features of Patent claim 1, and also by means of the method with the features of Patent claim 9.

The present invention is based on the idea that a first structural element is provided from a first material, which has at least one first bonding surface, and a second structural element is provided from a second material which differs from the first material, which has at least one second bonding surface, wherein a coating, which has the second material of the second structural element, is applied at least to the first bonding surface of the first structural element. An adhesive bond is then provided between the coating, which is applied to the first bonding surface of the first structural element, and the second bonding surface of the second structural element, in order to adhesively bond the two structural elements to each other.

In this way, the present invention has the advantage in relation to the known approaches that before providing the adhesive bond the corresponding surfaces of the two structural elements which are to be adhesively bonded can be pretreated by means of the same pretreatment methods and pretreatment materials, and can be adhesively bonded by means of the same bonding adhesives. As a result of this, the possibility of a secure adhesive bond between structural elements of a titanium alloy, for example, and structural elements of an aluminium alloy, for example, is ensured, wherein the adhesively bonded structure is advantageously producible in a simple and inexpensive way.

Advantageous developments and enhancements of the adhesive bonding arrangement which is disclosed in Patent claim 1, and also the method which is disclosed in Patent claim 9, are found in the dependent claims.

According to a preferred development, the first structural element has a titanium material or suchlike. By coating a structural element which comprises a titanium material with another coating material which is easier to handle during adhesive bonding, pretreatment measures of titanium material, such as sand blasting, abrading or suchlike, which are costly and only conditionally used in aircraft construction, can be dispensed with. The term “titanium material” in the present case comprises both pure titanium and titanium alloys.

According to a further preferred development, the first structural element is formed as a stringer for forming a stiffening means, as a doubler or as a crack-stopper to prevent crack formations or crack propagations, or suchlike.

According to a further preferred development, the coating preferably has at least a thickness of approximately 0.2 μm. The coating comprises, for example, an aluminium material, for example, an aluminium alloy, in dependence upon the second structural element which is to be adhesively bonded. Especially in aircraft construction, one structural element, like, for example, a skin panel, stringer, frame, a rib or suchlike, in most cases comprises an aluminium material. By coating a first structural element which comprises, for example, a high-strength material, like, for example, a titanium material, with aluminium or a suitable aluminium alloy, similar surface materials can be pretreated together and correspondingly advantageously adhesively bonded to each other. In this case, the coating can be applied to the first bonding surface of the first structural element, for example by means of a plating process, by means of a vapour deposition process, or suchlike. The coating is preferably applied to the first bonding surface of the first structural element during production of and/or before any rolling of the first structural element, so that such rolling processes proceed without damage of the corresponding rollers. The coating can be applied to the first structural element both on one side and on both sides, i.e. either simply on the surface of the first structural element which is to be adhesively bonded, or else on the surface which faces away from the adhesive bond.

According to a further preferred development, the second structural element has an aluminium material, magnesium material, a monolithic or laminated material, a composite material, and/or suchlike. The second structural element is especially formed as a structural element of a lightweight structure of an aircraft, i.e. for example as a frame, rib or suchlike.

Furthermore, it is conceivable that the material of the second structural element, and therefore the material of the coating of the first bonding surface of the first structural element, comprises a hybrid material, especially a fiber composite-metal laminate.

An advantageous development of the invention provides that the structural elements are formed as elements of a lightweight structure, preferably an aircraft structure. The term “structural element” in this case especially also comprises framework structures, laminated components, for example, which are manufactured in prior manufacturing steps, stringers, outer skin elements, outer skin structures, and/or suchlike. In this case, at least one structural element can comprise a metal sheet, wherein the term “metal sheet” comprises thin-walled, basically two-dimensional components, which comprise both a monolithic or homogenous material, as the case may be, or a hybrid material, for example laminated material.

In this connection, hybrid materials can exist as laminated materials, like, for example, laminated aluminium materials, fiber composite-metal laminates, for example on an aluminium basis, fiber-reinforced laminated aluminium materials, carbon fiber-reinforced composite materials, or suchlike. Fiber reinforcements can also comprise, for example, glass fibers, polyaromatic amide fibers, aluminium oxide fibers, silicon carbide fibers, basalt fibers, aluminium wires, titanium wires, magnesium wires or suchlike, in addition to the already mentioned carbon fibers. Fiber composite-metal laminates are known, for example, as glass fiber reinforced (GLARE) material or as aramide-aluminium alloy (ARALL).

An especially advantageous development of the invention provides, furthermore, that the adhesive bonding arrangement, which is to adhesively bond the two structural elements, comprises a layer which is reinforced by means of fibers, which layer, for example, is a component part of the applied adhesive bond. The fibers which are arranged in the adhesive bond between the structural elements in this case can be unidirectionally orientated. It is also conceivable that the fibers which are arranged in the adhesive layer between the structural elements are bi-directionally or poly-directionally orientated. In this case, the fibers can be arranged in a woven structure, such as a lattice, a net, or suchlike. The fibers preferably have a minimum length of 10 mm, and also preferably have a diameter of between 0.001 mm and 0.3 mm. Before or during the adhesive bonding, the fibers can be bonded into a plastic matrix, for example in a bonding adhesive, as already explained above. After the adhesive bonding, the layer of bonding adhesive of the adhesive bond has a layer thickness of preferably 0.01 mm to 0.3 mm. The fibers can be formed, for example, as glass fibers, carbon fibers, polyaromatic aramide fibers, aluminium oxide fibers, silicon carbide fibers, basalt fibers, or suchlike, and also as aluminium wires, titanium wires, magnesium wires, or suchlike.

### BRIEF EXPLANATION OF THE DRAWINGS

The invention is subsequently explained in detail based on exemplary embodiments with reference to the accompanying figures of the drawing.

In the drawing, from the figures:

FIG. 1 shows a schematic cross sectional view of an adhesive bonding arrangement, according to a first preferred exemplary embodiment of the present invention;

FIG. 2 shows a schematic cross sectional view of a first structural element, which is provided on one side with a coating, according to a preferred exemplary embodiment of the present invention;

FIG. 3 shows a schematic cross sectional view of a first structural element, which is provided on both sides with a coating, according to a preferred exemplary embodiment of the present invention;

FIG. 4 shows a perspective view of a lightweight structure consisting of two structural elements of different materials, which are adhesively bonded to each other, according to a preferred exemplary embodiment of the present invention, and

FIG. 5 shows a simplified, schematic perspective view in section of the construction of a reinforced adhesive bond, according to a preferred exemplary embodiment of the present invention.

### DESCRIPTION OF PREFERRED EMBODIMENTS

In the figures of the drawing, like designations refer to like components, or functionally similar components, so far as nothing to the contrary is specified.

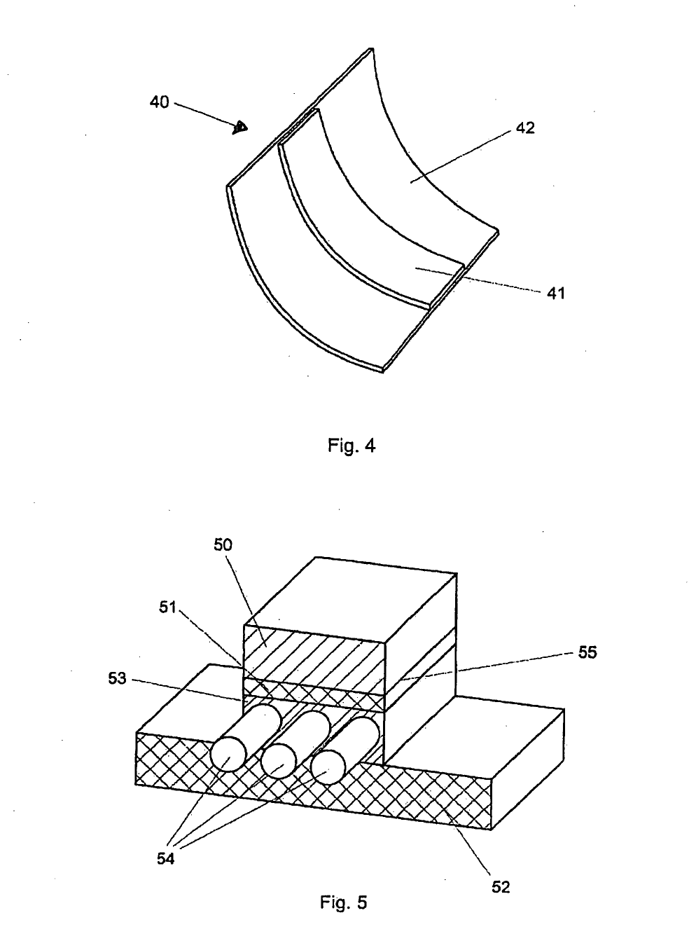

FIG. 1 illustrates an exemplary adhesive bonding arrangement 1 according to an exemplary embodiment of the present invention. A first structural element 2 of a lightweight structure 40, which is exemplarily shown in FIG. 4, comprises a titanium alloy. On its surface 3 which faces the adhesive bond, the structural element 2 is provided with a coating 4, which is preferably applied by plating. The coating material is advantageously selected in such a way that it corresponds to the material of the second structural element 8 which is to be adhesively bonded to the first structural element 2, in the present case as an aluminium alloy, for example.

The coating 4 according to the present exemplary embodiment comprises an oxide layer 5′, which the aluminium alloy forms on its surfaces which are exposed to the atmosphere immediately after the coating. Within the scope of the pretreatment measures for preparation of the adhesive bonding arrangement 1, for example a suitable primer is applied to the oxide layer 5′, which forms a primer layer 6′.

The second structural element 8 of the lightweight structure 40, which is to be adhesively bonded to the first structural element 2 via the second bonding surface 9, preferably comprises an aluminium alloy which is similar to the coating 4. An oxide layer 5″ is also located on the surface of the second bonding surface 9 of the second structural element 8, and also a primer layer 6″ which is applied during the pretreatment. An adhesive layer 7 of a suitable bonding adhesive is located between the primer layers 6′ and 6″, which firmly interconnects the two structural elements 2 and 8. Bonding agents and primers in this case are matched to the adhesive bonding of the aluminium alloys of the coating 4 and of the second structural element 8.

The adhesive bonding arrangement 1 which is exemplarily described above solves the problem of production of a secure and inexpensive adhesive bond (i.e. adhesive bonding connection) between structural elements 2 of titanium materials and structural elements 8 of aluminium materials by a coating 4 of aluminium material being applied at least to the surface 3 which faces the adhesive bond, i.e. the first bonding surface 3 of a first structural element 2 of a titanium material, before the adhesive bonding.

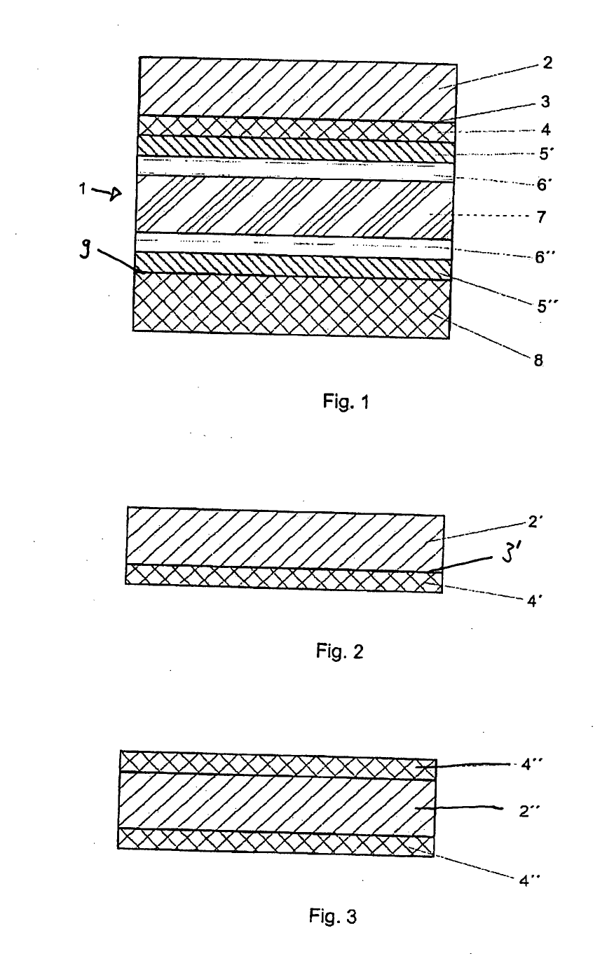

The application of a coating 4′, 4″ which comprises an aluminium material to a structural element 2′, 2″ of a titanium material, in this case can be carried out on one side, which basically corresponds to a further exemplary embodiment according to FIG. 2, or can be carried out on both sides, which corresponds to a still further exemplary embodiment according to FIG. 3. It is essential that the coating 4′, 4″ is applied before the adhesive bonding and before the pretreatment of the surfaces which are to be adhesively bonded together, for example before applying the primer layers 6′ 6″.

The coating of workpieces, such as structural elements which are constructed as metal sheets, in this case can be carried out according to different methods. It is possible, for example, that the coating of an aluminium alloy is applied before rolling of a metal sheet of a titanium alloy. As a result of this, the rolling process is enhanced with regard to wear of the rolling rollers.

Furthermore, the coating of structural elements of titanium materials with aluminium or an aluminium alloy enables the use of the same pretreatment measures for the preparation of the adhesive bond for the structural elements of titanium materials and also for the structural elements of aluminium materials. Thus, it is possible to apply or use, as the case may be, similar methods, like, for example, surface cleaning, anodization and suchlike, and also similar substances, like, for example, pretreatment baths, primers, bonding adhesives and suchlike, for the structural elements of titanium materials which are provided with the coating, in the manufacturing step in which the adhesive bond (i.e. adhesive bonding connection) is produced.

The construction of a lightweight structure 40 of structural elements of different materials which are adhesively bonded to each other is exemplarily shown in FIG. 4. The structural elements, for example, are a doubler 41 of a titanium alloy, and also an outer skin 42 of an aluminium alloy, of a passenger aircraft. The doubler 41 is provided with a coating of an aluminium alloy both on the outer skin 42 and on its surface which faces the adhesive bond. The aluminium alloy of the coating and the aluminium alloy of the outer skin 42 in this case are preferably identical. As a result, the production of the adhesive bond is considerably simplified.

An enhancement of the properties of the adhesive bond, for preventing crack propagation in individual components of the lightweight structure, is possible by means of reinforcing the adhesive layer 53 which is exemplarily shown in FIG. 5. The view of the primer layers 6′, 6″ and oxide layers 5′, 5″, which are shown in FIG. 1, were dispensed with in FIG. 5 for the purpose of clarity.

A structural element 50 of a titanium alloy is provided with a coating 51 of an aluminium alloy. The structural element 50, by its surface 55 which is provided with the coating 51, is adhesively bonded to a structural element 52 of an aluminium alloy by means of an adhesive layer 53. Fibers 54 are arranged in the adhesive layer 53. The fibers 54 are arranged parallel to each other in a unidirectional orientation. It is also conceivable that the fibers 54 are bi-directionally or polydirectionally arranged so that they intersect. In this case, the fibers 54 can be arranged in a weave structure. The fibers 54 can be coated on their surface by a surface active agent, or they can be embedded in a plastic matrix.

The method for producing an adhesive bonding arrangement between a first and a second structural element preferably proceeds as follows: first, a coating, preferably of the material of the second structural element or of a material which contains at least the material of the second structural element, is applied to a predetermined surface of the first structural element which is to be adhesively bonded to the structural element. This can especially be carried out before or during the production process of the first structural element, but also after it. Next, the surfaces of the structural elements which are to be adhesively bonded to each other are suitably pretreated together. The pretreatment in this case complies exclusively with the materials of the bonding surfaces which are to be adhesively bonded and not with the materials of the structural elements. After the pretreatment, the first structural element is adhesively bonded to the second structural element, wherein the coated surface of the first structural element is adhesively bonded to the second structural element. The adhesive bonding in this case preferably takes place under a vacuum, for example in an autoclave.

The described method is also suitable for adhesively bonding laminated materials, like, for example, fiber composite-metal laminates, such as GLARE. It is also conceivable to use the invention in conjunction with composite materials, which are referred to as composites, especially carbon fiber-composite materials. The pretreatment of the surfaces of the structural elements which are to be adhesively bonded is simplified by means of coating the surface of the first structural element of titanium material which is to be adhesively bonded, since homogenous treatment and adhesive bonding methods, and also homogenous materials, can be used for both structural elements.

The method according to the invention, and also the adhesive bonding arrangement according to the invention, enables riveted doublers of titanium, for example in the door and hatch corner regions, and also in the region of longitudinal seams, to be replaced by adhesively bonded doublers of titanium. The possibility of a secure adhesive bond also enables the use of adhesively bonded crack-stoppers in the longitudinal or transverse direction of the aircraft fuselage or wing to prevent propagation of possible cracks in the aircraft structure. The possibility of producing a secure, inexpensive and simply producible adhesive bonding arrangement between structural elements of aluminium alloy, like, for example, stringers, clips, skin panel and suchlike, and structural elements of titanium alloys, like, for example, doublers, crack-stoppers, stiffening elements and suchlike, has multifarious advantages.

The adhesively bonded structure has enhanced fatigue resistance properties on account of the reduction of the number of possible crack initiation points. Such crack initiation points in conventionally produced connections are predominantly the rivet holes. As a result, it is possible to increase the level of permissible stresses in the structural components, and to correspondingly reduce the weight, for example of an aircraft structure. A further weight reduction results on account of the saving of rivets which are no longer required in an adhesive bond.

Riveting of doublers of titanium or titanium alloys is a very cost-intensive process. The rivets which are used for riveting the doublers are in most cases produced from titanium and very expensive. The adhesive bonding method represents a more cost-effective connecting process.

Adhesive bonding of structural elements of titanium alloys to structural elements of aluminium alloy, forming a structural component of an aircraft structure, such as a shell, can be carried out together with adhesive bonding of structural elements of aluminium alloys to each other in one working step. The time which is required for production of the shell is very much reduced as a result, since the working step of subsequent riveting of structural elements of titanium alloys to structural elements of aluminium alloys which were adhesively bonded to each other beforehand, which step is carried out up to now in a further production hall and in most cases in a different production hall, is inapplicable. Furthermore, transporting costs between the production halls are also inapplicable.

The view in the figures is not true to scale. In particular, individual layer thicknesses are shown in a much exaggerated manner.

Although the present invention was previously described based on preferred exemplary embodiments, it is not limited to those but is modifiable in a diverse manner.

What is claimed is:

1. An adhesive bonding arrangement for adhesively bonding two structural elements, comprising:
a first structural element, which comprises a first material and has at least one first bonding surface;
a second structural element, which comprises a second material which differs from the first material and has at least one second bonding surface; and
an adhesive bond between the first bonding surface of the first structural element and the second bonding surface of the second structural element;
wherein the first structural element comprises a plated or vapor-deposited coating, which comprises the second material of the second structural element, at least on the first bonding surface.

2. The adhesive bonding arrangement according to claim 1,
wherein the first structural element comprises a high-strength material.

3. The adhesive bonding arrangement according to claim 1,
wherein the first structural element comprises a titanium material.

4. The adhesive bonding arrangement according to claim 1,
wherein the first structural element is at least one of a stringer for forming a stiffening means, a doubler and a crack-stopper to prevent crack formations or crack propagations.

5. The adhesive bonding arrangement according to claim 1,
wherein the coating has at least a thickness of approximately 0.2 μm.

6. The adhesive bonding arrangement according to claim 1,
wherein the second structural element comprises at least one of an aluminium material, a magnesium material, a monolithic material, a laminated material and a composite material.

7. The adhesive bonding arrangement according to claim 1,
wherein at least one of the first structural element and the second structural element is a structural element of a lightweight structure of an aircraft.

8. The adhesive bonding arrangement according to claim 1,
wherein the adhesive bond has a thickness of approximately 0.01 mm to 0.3 mm.

9. The adhesive bonding arrangement according to claim 1,
wherein the adhesive bond comprises at least one of fibers and structures which are woven from fibers, wherein the fiber length, for example, is at least 10 mm and the fiber diameter is approximately 0.001 mm to 0.3 mm.

10. A method for producing an adhesive bond between two structural elements, with the following method steps:
providing a first structural element of a first material and having at least one first bonding surface;
providing a second structural element of a second material, which differs from the first material, and having at least one second bonding surface;
plating or vapor depositing a coating, which has the second material of the second structural element, onto at least the first bonding surface of the first structural element; and
providing an adhesive bond between the coating, which is applied to the first bonding surface of the first structural element, and the second bonding surface of the second structural element, for adhesively bonding the same to each other.

11. The method according to claim 10,
wherein the coating is applied to the first bonding surface of the first structural element by means of a plating process.

12. The method according to claim 10,
wherein the coating is applied to the first bonding surface of the first structural element by means of a vapour deposition process.

13. The method according to claim 10,
wherein the coating is applied to the first bonding surface of the first structural element during production of and/or before any rolling of the first structural element.

14. The method according to claim 10,
wherein the coating is applied to the first structural element on one side or on both sides.

15. The method according to claim 10,
wherein the adhesive bond, for strengthening the same, is formed with at least one of integrated fibers and structures which are woven from fibers,
wherein the fibers are bonded into the adhesive bond preferably before or during the provision of the adhesive bond.

16. The method according to claim 10,
wherein the first structural element, after application of the coating, and the second structural element, for providing the adhesive bond, are pretreated or treated by means of the same process steps or the same means for example by means of a homogenous surface cleaning, a homogenous anodization, a homogenous pretreatment bath, a homogenous primer, a homogenous bonding adhesive, or suchlike.
